(19) United States
(12) Patent Application Publication
(10) Pub. No.: US 2017/0203548 A1
(43) Pub. Date: Jul. 20, 2017

(54) SKIRTING BOARD, DECORATIVE SYSTEM AND METHOD FOR MANUFACTURING A SKIRTING BOARD

(71) Applicant: IVC, BVBA, Avelgem (BE)

(72) Inventors: Louis Wilfried Lieven BALCAEN, Spiere (BE); Cindy VAN MOORLEGHEM, Wortegem-Petegem (BE)

(73) Assignee: IVC, BVBA, Avelgem (BE)

(21) Appl. No.: 15/404,882

(22) Filed: Jan. 12, 2017

(30) Foreign Application Priority Data
Jan. 14, 2016 (BE) 2016/5026

(51) Int. Cl. B32B 21/08; B32B 27/30; E04F 19/04; B32B 7/04; B32B 37/00; B32B 3/30; B32B 21/02

(52) U.S. Cl. CPC B32B 21/08; B32B 3/30; B32B 27/30; B32B 21/02; B32B 7/045; B32B 37/0084; E04F 19/04; B32B 2317/16; B32B 2327/06; B32B 2471/00; E04F 2019/0431

(57) ABSTRACT

A skirting board has a core with an upper side, an opposed lower side and a front side and back side situated opposite to each other and extending between the lower side and the upper side, and a plate-shaped material attached to the core and covering at least the front side. The plate-shaped material, seen from the upper side of the core, extends to beyond the lower side of the core.

The present invention relates to a skirting board, comprising a core with an upper side, an opposed lower side and a front side and back side situated opposite to each other and extending between the upper side and the lower side, and a plate-shaped material, which is attached to the core and covers at least the front side.

Such skirting board is known in the state of the art. The known skirting board has a core of pressed wood fibers onto which a plate-shaped material in the form of a synthetic material sheet is laminated. The sheet serves for protecting the core against external influences, such as mechanical impact or moisture. Further, the sheet may be provided with a pattern for giving the skirting board, for example, a natural appearance, such as a wood or stone pattern.

This aim is achieved by the skirting board according to the present invention, wherein the plate-shaped material, seen from the upper side of the core, extends to beyond the lower side of the core.

This means that the plate-shaped material protrudes from the lower side of the core, such that the free extremity of the plate-shaped material is situated at a distance from the lower side of the core. The distance between the free extremity of the plate-shaped material and the lower side of the core in practice will be shorter than the height of the front side of the core. When the skirting board is attached at the location of a transition between a floor and a wall, the back side of the core is directed towards the wall and the lower side of the core is directed towards the floor. In practice, the plate-shaped material may have a higher density than the core. An advantage of the skirting board according to the invention is that, when installing the skirting board on a floor, the core is situated at a distance from the floor. This offers the possibility of making the core of a material which is not resistant against water and making a plate-shaped material of a waterproof material in order to obtain a waterproof skirting board. In the state of the art, it is not common to make high-quality skirting boards, and certainly not waterproof skirting boards, of relatively cheap material. When use is made of economically advantageous, low-quality material for the core of the skirting board, for example, material having a very low density, the back side of the core can be attached to a wall, for example, with glue instead of with the common mounting clips. Further, the skirting board according to the invention offers the possibility of accommodating cables in the space underneath the core at the side of the plate-shaped material directed towards the core.

By the term “plate-shaped material” is meant that it is a thin piece of a certain material, the thickness of which is much smaller than the length and width, for example, a sheet, a lamina, a skin, a fleece, a slab, a foil and the like.

At least the side of the plate-shaped material directed away from the core can cover the front side and the upper side of the core in an uninterrupted manner, such that a natural appearance of the skirting board can be obtained when it is provided at the location of a transition between a floor and a wall. When there is a sharp bend between the upper side and the front side, it may be an advantage to interrupt the plate-shaped material at the side directed towards the core, for example, by a notch or groove, in order to restrict the local tension in the material.

In a practical embodiment, the thickness of the plate-shaped material is smaller than the distance between the front side and the back side of the core, and/or smaller than the distance between the upper side and the lower side of the core. The plate-shaped material thus forms a relatively thin layer on the core. In practice, it can have a thickness which is larger than 1.8 mm. Preferably, the thickness is larger than 2 mm in order to provide sufficient strength without necessitating support of the core for the side directed to the core at the location of the protruding portion. In practice, the thickness of the plate-shaped material shall be smaller than 5 mm.

The plate-shaped material can be a synthetic material sheet. The synthetic material sheet can be adhered to the core, for example, by means of gluing or laminating. In a practical embodiment, the synthetic material sheet is made of a vinyl-containing material, preferably of luxury vinyl flooring material. From this, also floor coverings, such as floor tiles or floor panels, are made, which products in general also are indicated by LVT (Luxury Vinyl Tile). Luxury vinyl flooring, such as luxury vinyl tile (LVT) is a category of thermoplastics-based floor covering products. Luxury vinyl flooring products can be provided as roll material, which is glued onto a basic layer, but also as planks, which can be provided with a locking profile for interconnecting the planks. A luxury vinyl flooring product can be composed of three layers: a basic layer, a decoration layer and a transparent, possibly wear-resistant, top layer. A plate or panel of LVT material, on the one hand, is bendable, however, on the other hand, in particular with relatively short pieces, is strong in a direction in the plane of the plate-shaped material.

The core of the skirting board can be made of a wood-containing material, for example, pressed wood fibers, such as MDF, HDF, WPC or a thermoplastic or extruded material, or the like.

In a specific embodiment, the portion of the plate-shaped material protruding from the lower side of the core is provided with at least one groove extending in the longitudinal direction of the skirting board and being situated at the side of the plate-shaped material directed towards the core. This offers the possibility of adapting the height of the skirting board in a simple manner by cutting the plate-shaped material at the location of the groove by means of a simple cutter knife.

In a further embodiment, the groove is a first groove and the plate-shaped material is provided with at least a second groove extending parallel to the first groove and being situated at the side of the plate-shaped material directed toward the core. Consequently, the end user is enabled to choose from diverse skirting board heights.

The invention also relates to a decoration system, comprising a floor covering which is made of a luxury vinyl flooring material and a skirting board according to any of the preceding claims, wherein the plate-shaped material is also made of a luxury vinyl flooring material. An advantage of this decoration system is that the skirting board and the floor are made of the same material and have the same appearance. The decoration pattern and/or the surface structure then can be, for example, the same, such that a perfect “matching” between floor covering and skirting board is obtained. It is also known that luxury vinyl flooring offers a high degree of wear resistance and waterproofness, such that the skirting board also comprises these features.

In this respect, it is noted that the skirting board of the decoration system does not have to be limited to a skirting board wherein the plate-shaped material protrudes from the lower side of the core, such as described herein above. For example, it is also possible that the decoration system comprises a floor covering of vinyl flooring material and that the core of the skirting board, at the front side and the upper side, is covered with the same vinyl flooring material or at least a top layer and decoration layer thereof, without the material protruding beyond the core. Generally spoken, this relates to: a decoration system, comprising a floor covering which is made of a luxury vinyl flooring material with at least a top layer, decoration layer and basic layer, and a skirting board with a core which at least partially is covered with at least the top layer and decoration layer of the same luxury vinyl flooring material.

The invention also relates to a method for manufacturing a skirting board, such as described herein above, wherein the core to be formed comprises a first core part and a second core part, which core parts are secured to the plate-shaped material and each are provided with respective contact locations situated at a distance from each other, wherein the first and second core part are moved towards each other with a bending of the plate-shaped material and are secured to each other at the location of the contact locations in order to form the core of the skirting board. This appears to be a simple, however, effective method for bending the plate-shaped material at the desired location and forming the final core of the skirting board.

The first and second core part can be formed by first securing the plate-shaped material to a substrate and thereafter providing a V-groove in the substrate in the direction of the plate-shaped material. Hereby, after bringing the core parts towards each other, a miter connection is created. The plate-shaped material is bent at the location of the tip of the V-groove. In practice, the V-groove can continue up into the plate-shaped material, such that the two formed core parts after the milling treatment are separate from each other.

The boundary surfaces at opposite sides of the V-groove can form the contact locations, which are glued to each other in order to form the core of the skirting board. The side of the one core part adhered to the plate-shaped material forms the upper side of the final core, whereas the side of the other core part adhered to the plate-shaped material forms the front side of the final core.

In a particular embodiment, the plate-shaped material, seen from the substrate, successively is provided with at least a basic layer, decoration layer and transparent top layer, wherein the tip of the V-groove remains remote from the top layer and preferably remains remote from the decoration layer. The farther the top of the V-groove is sitting in the plate-shaped material, the easier it will be to bend the material around a corner.

The invention will be further illustrated herein below by means of drawings, which very schematically represent embodiment examples of the invention.

FIG. 1 is a cross-sectional view of an embodiment example of a skirting board according to the invention;

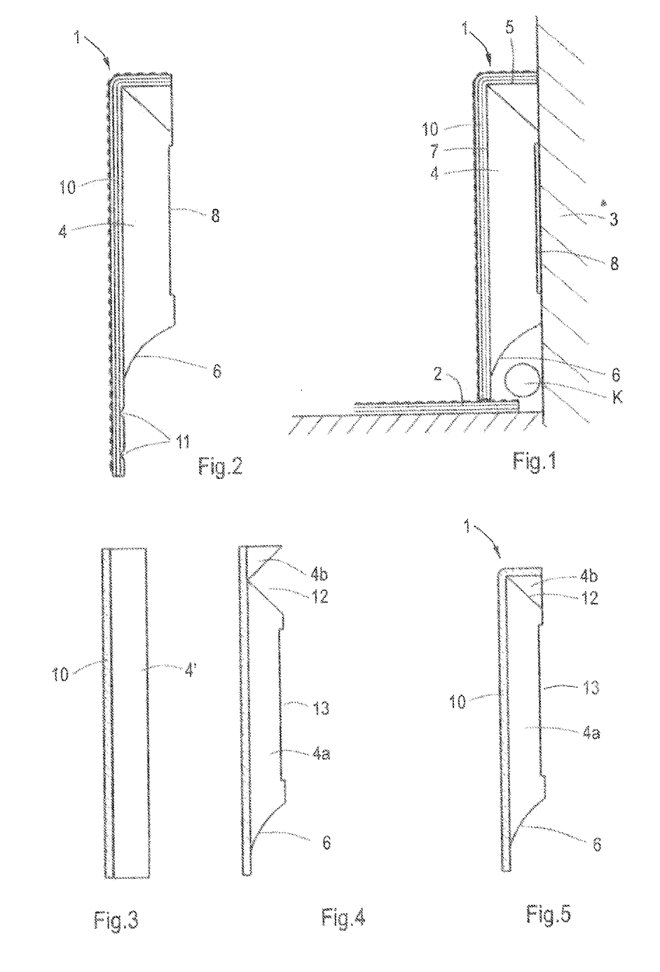

FIG. 2 is a same view as FIG. 1 of an alternative embodiment example of the skirting board;

FIGS. 3-5 are cross-sectional views of a skirting board in various production stages for illustrating an embodiment example of the method according to the invention;

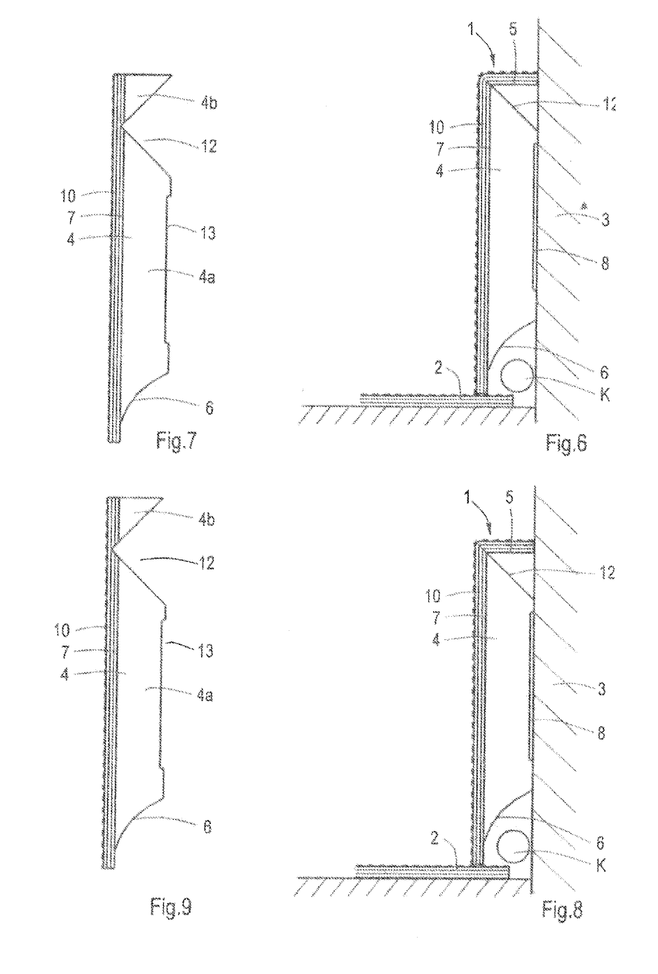

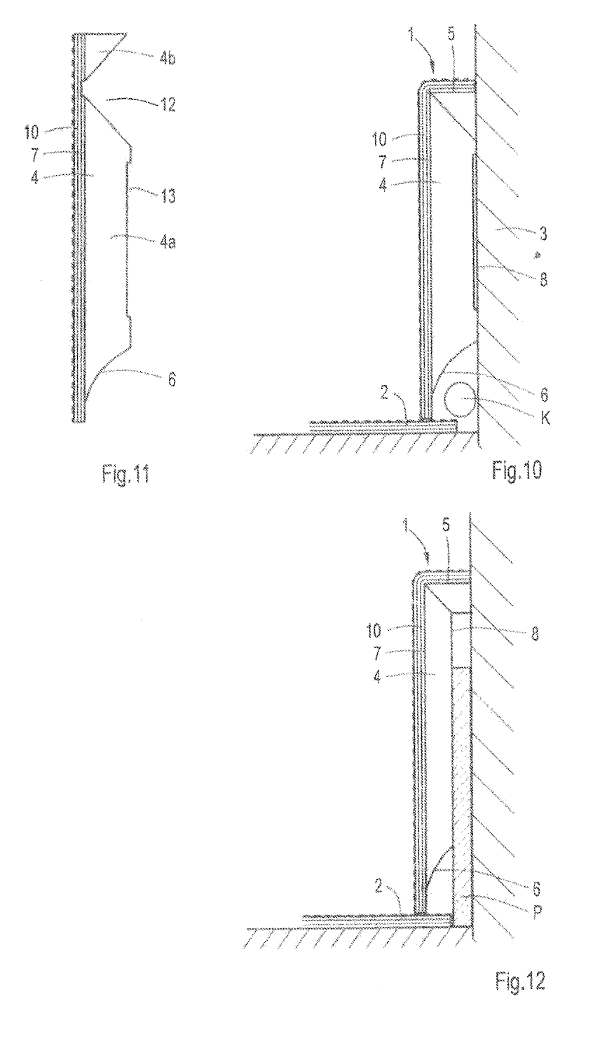

FIGS. 6 and 7, 8 and 9, 10 and 11 are views, respectively corresponding to FIGS. 4 and 5, of alternative embodiment examples;

FIG. 12 is a view corresponding to FIG. 1 of an alternative skirting board, wherein the skirting board is realized as a renovation skirting board;

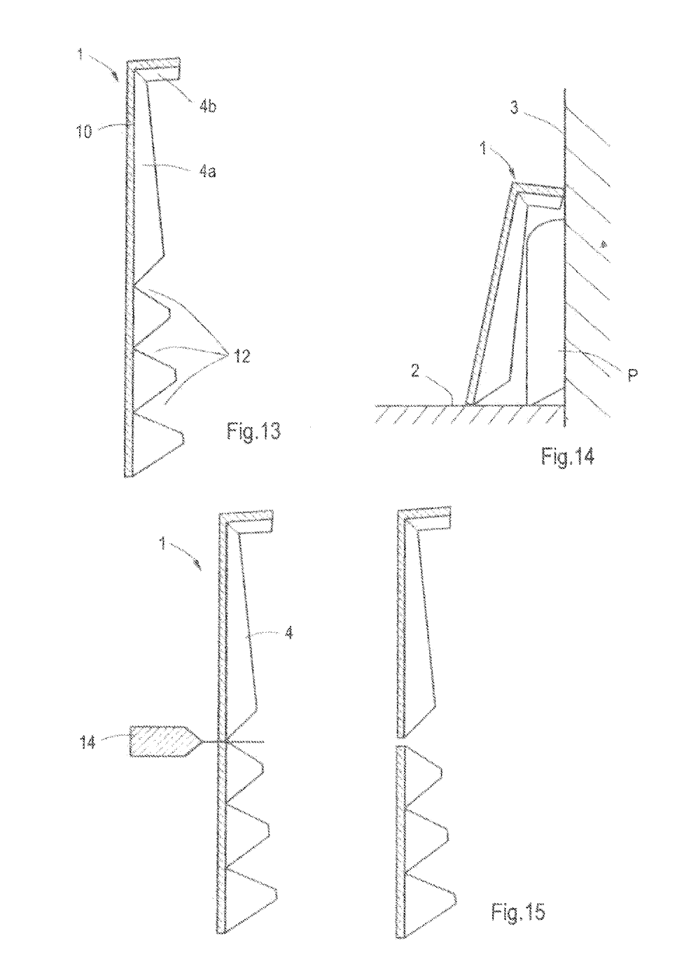

FIG. 13 is a view corresponding to FIG. 12 of an alternative embodiment example of a renovation skirting board;

FIG. 14 is a same view as FIG. 13, however, illustrating a situation in which the skirting board according to FIG. 13 is shortened and mounted;

FIG. 15 is a view corresponding to FIG. 13, wherein the shortening of the skirting board according to FIG. 13 is illustrated.

FIG. 1 shows an embodiment example of a decoration system with a skirting board 1 according to the invention. The decoration system comprises a floor covering 2 on which the skirting board 1 is resting. Further, FIG. 1 shows that the skirting board 1 is attached against a wall 3. Hereby, the skirting board 1 forms a transition between the floor covering 2 and the wall 3. In this case, the floor covering 2 comprises LVT panels. LVT is the abbreviation for Luxury Vinyl Tile, and LVT floors also are indicated as PVC floors. PVC floors often are composed of three layers, for example: a basic layer of 1-4 mm, comprising a vinyl composite, which comprises vinyl with fillers, such as plasticizers, binding agents and stabilizers, a transparent top layer, which, for example, comprises a so-called rigid vinyl film having a thickness of 0.2-1 mm and comprises vinyl with little or no plasticizers, and a decoration layer situated between the basic layer and the top layer, which can comprise a vinyl sheet of 0.1-1 mm with a printed thereon decoration pattern. A plate or panel of LVT material, on the one hand, is bendable, however, on the other hand, is rigid in a direction in the plane of the plate-shaped material. An advantage of LVT is that it is a waterproof and wear-resistant material. The LVT floor according to FIG. 1 in this case also has three layers, wherein the top layer is provided with a surface structure, for example, a wood nerve structure.

The embodiment example represented in FIG. 1 of the skirting board 1 comprises an opposed lower side 6 and a front side 7 and back side 8 situated opposite to each other. The front side 7 and the back side 8 extend between the lower side 6 and the upper side 5. Further, the skirting board 1 is provided with a plate-shaped material 10, in this case the same type of LVT material as the floor covering 2, which is attached to the front side 7 and the upper side 5 of the core 4, for example, by means of gluing or laminating. In FIG. 1, a triple-layered LVT material is shown, however, a deviating number of layers are possible as well. As the plate-shaped material 10 of the skirting board 1 consists of the same material as that of the floor covering 2, the top layer thereof also has the same surface structure. Moreover, it is possible that the plate-shaped material 10 in fact has the same top layer and decoration layer as the floor covering, however, that the basic layer is omitted or, for example, is thinner than that of the floor covering. Hereby, a thinner plate-shaped material 10 can be obtained, whereas the same appearance is maintained.

The plate-shaped material 10 covers the upper side 5 as well as the front side 7 of the core 4 and is continues uninterruptedly from the wall 3 along the upper side 5 and the front side 7 up to beyond the lower side 6 of the core 4. In the installed situation of the skirting board 1, as shown in FIG. 1, the free extremity of the plate-shaped material 10 rests on the floor covering 2. Hereby, a distance is present between the floor covering 2 and the core 4. An advantage hereof is that, when water is reaching the space underneath the core 4, coming from the floor covering 2, the core 4 remains free from the water. Therefore, the core 4 can be made of a relatively cheap, light and water-absorbing material, such as light-weight MDF with a lower density than 600 kg/m³. However, the core 4 also can be made of another, possibly wood-containing, material, such as WPC, thermoplastic or extruded material. In FIG. 1 is also illustrated that the space underneath the core can be applied for hiding a cable K from view.

FIG. 1 represents a cross-section of a more or less block-shaped skirting board 1, wherein the plate-shaped material forms an angle of 90° around the core 4, however, many alternative forms with other corner forms and corner dimensions are possible. The thickness of the plate-shaped material 10 is smaller than the distance between the front side 7 and the back side 8 of the core 4 and also smaller than the distance between the upper side 5 and the lower side 6 of the core 4. The thickness of the plate-shaped material preferably is larger than 1.8 mm and more particularly the thickness is larger than 2 mm, as then the portion protruding from the lower side 6 of the core 4 offers sufficient strength. On the other hand, it is an advantage when the thickness is smaller than 2.5 mm, such that it still can be easily bent over an angle of 90° of the core 4.

FIG. 2 represents an alternative embodiment example of the skirting board 1, wherein the portion of the plate-shaped material 10 protruding from the lower side 6 of the core 4 is provided with two notches 11. The notches 11 are situated at the side of the plate-shaped material 10 directed towards the core 4 and extend parallel to each other in the longitudinal direction of the skirting board 1. Due to the presence of the notches 11, the height of the skirting board 1 can be shortened in a simple manner, as desired, for example, by means of a cutter knife. The notches 11 are made only in the basic layer of the plate-shaped material 10 in order to provide for that the notches 11 are invisible at the opposite side of the plate-shaped material 10.

FIGS. 3-5 show in steps an embodiment example of the method for manufacturing a skirting board 1 according to the invention. First, a large sheet of LVT of, for example, approximately 2×2.5 m, from which floor panels can be cut as well, is glued onto a substrate of MDF with a thickness of, for example, 8 mm, after which the obtained semi-finished product is cut to separate strips. A cross-sectional view of such strip is shown in FIG. 3. The substrate shown in FIG. 3, of which later the core 4 will be created, is indicated with reference number 4′. The substrate 4′ is block-shaped and does not yet have the form of the core 4, such as a skirting board 1 according to the invention. The length of the strip can be made in a simple manner to the standard dimension for skirting boards of 2.4 m.

FIG. 4 illustrates the strip after the substrate 4′ has been milled at various locations. Amongst others, a V-groove 12 has been milled into the substrate 4′, such that two separate core parts 4a and 4b are formed. The core parts 4a and 4b have directed towards each other contact surfaces at opposite sides of the V-groove 12, which contact surfaces, in a subsequent treatment step, are brought towards each other by bending the plate-shaped material 10 attached to the core parts 4a, 4b, after which the core parts 4a and 4b are glued to each other at the location of the contact surfaces. The result thereof is shown in FIG. 5, wherein the location of the glued contact surfaces is indicated by reference number 12′.

FIG. 4 further shows that after the milling treatment a recess 13 is formed. In the final skirting board 1, this recess serves for receiving glue for attaching the skirting board 1 to the wall. Further, FIG. 4 shows that the substrate 4′ is milled such that the lower side 6 of the core 4 of the finally to be formed skirting board 1 with the portion of the plate-shaped material 10 protruding from the lower side 6 is created. The resulting skirting board 1 is shown in FIG. 5.

FIGS. 6 and 7, 8 and 9, 10 and 11 illustrate alternative embodiment examples of the method for manufacturing a skirting board 1. In these cases, the plate-shaped material is a triple-layered LVT material, as shown in FIG. 1, with successively a basic layer, decoration layer and top layer, as seen from the core 4. In FIGS. 7, 9 and 11 can be seen that the V-grooves 12 have different depths and shapes, which exerts an influence on the folding over of the LVT material. FIG. 7 shows that the V-groove 12 reaches up to the decoration layer, whereas FIG. 9 shows that the V-groove 12 reaches up to the top layer. In the situation according to FIG. 11, the V-groove 12 also reaches up to the decoration layer, but the tip of the V-groove 12 is flattened and the core parts 4a and 4b are lying farther apart than in the situation according to FIG. 7. Thereby, when folding over, the tension on the top layer and decoration layer of the plate-shaped material 10 is limited.

FIG. 12 shows an alternative embodiment example of the skirting board 1. In this case, the skirting board 1 is made as a renovation skirting board. This can be applied, for example, when renovating rooms which are provided with ceramic floors and skirting boards. In FIG. 12, an existing skirting board is indicated by the letter P. The core 4 of the skirting board 1 has a recess in which the existing skirting board P can be received. The back side 8 of the core 4 can be glued against the wall 3.

FIG. 13 shows an alternative embodiment example of a renovation skirting board 1. The core of the skirting board 1 is indicated by 4a and 4b for the core parts in order to indicate that this skirting board 1 can be manufactured in a same manner as the herein above-described skirting boards and is illustrated, for example, in FIGS. 4 and 5. FIG. 13 also shows that the core of the skirting board 1 is provided with three notches 12. These facilitate shortening the skirting board 1, such that the desired height of the skirting board 1 can be chosen at the building site by the installing person. In FIG. 15, it is illustrated that the plate-shaped material 10 at the location of a tip of one of the notches 12 can be cut through with a cutter knife 14. FIG. 14 shows that the renovation skirting board 1 resulting therefrom can be placed over an existing skirting board P and can be attached thereto, for example, by means of glue.

In FIG. 13-15 is shown that in the represented embodiment example the plate-shaped material 10 of the renovation skirting board 1 does not protrude from the lower side of the core. Generally, such renovation skirting board can be defined as follows: a skirting board, comprising a core with an upper side, an opposed lower side and a front side and back side situated opposite to each other and extending between the upper side and the lower side, and a plate-shaped material, which is attached at least to the front side of the core, wherein the back side of the core is provided with one or more notches extending at a distance from the upper side in the longitudinal direction of the skirting board. Preferably, the tip of a notch reaches up to the plate-shaped material. The plate-shaped material can have the dimensions and features as described herein above. Also, the method for manufacturing such skirting board can correspond to the herein above-described method in respect to the manufacture of core parts and the folding over of the plate-shaped material.

The invention is not limited to the herein above-described embodiment examples, which can be varied in different manners within the scope of the claims.

1-16. (canceled)

17. A skirting board, comprising a core with an upper side, an opposed lower side and a front side and back side situated opposite to each other and extending between the lower side and the upper side, and a plate-shaped material, which is attached to the core and covers at least the front side, wherein the plate-shaped material, seen from the upper side of the core, extends to beyond the lower side of the core.

18. The skirting board according to claim 17, wherein at least the side of the plate-shaped material facing away from the core covers the front side and the upper side of the core uninterruptedly.

19. The skirting board according to claim 17, wherein the thickness of the plate-shaped material is smaller than the distance between the front side and the back side of the core and/or is smaller than the distance between the upper side and the lower side of the core.

20. The skirting board according to claim 17, wherein the thickness of the plate-shaped material is larger than 1.8 mm, preferably larger than 2 mm.

21. The skirting board according to claim 17, wherein the plate-shaped material is a synthetic material sheet.

22. The skirting board according to claim 21, wherein the synthetic material sheet is adhered onto the core.

23. The skirting board according to claim 21, wherein the synthetic material sheet is made of a vinyl-containing material.

24. The skirting board according to claim 23, wherein the synthetic material sheet is made of a luxury vinyl flooring material comprising at least a basic layer, decoration layer and transparent top layer.

25. The skirting board according to claim 17, wherein the core is made of a wood-containing material.

26. The skirting board according to claim 17, wherein the portion of the plate-shaped material protruding from the lower side of the core is provided with at least one groove, which extends in the longitudinal direction of the skirting board and is situated at the side of the plate-shaped material directed towards the core.

27. The skirting board according to claim 26, wherein the groove is a first groove and the plate-shaped material is provided with at least one second groove, which extends parallel to the first groove and is situated at the side of the plate-shaped material directed towards the core.

28. A decoration system, comprising a floor covering, which is made of a luxury vinyl flooring material, and a skirting board according to claim 17, wherein the plate-shaped material is also made of a luxury vinyl flooring material.

29. A method for manufacturing a skirting board according to claim 17, comprising the steps:
forming the core, said core comprising a first core part and a second core part,
securing said core parts to a plate-shaped material and each are provided with respective contact locations situated at a distance from each other,
moving the first and second core part towards each other by bending the plate-shaped material and
attaching the first and second core parts to each other at the contact locations in order to form the core of the skirting board.

30. The method according to claim 29, wherein the first and second core part are formed by first securing the plate-shaped material to a substrate and subsequently providing a V-groove in the substrate in the direction of the plate-shaped material.

31. The method according to claim 30, wherein the boundary surfaces on opposite sides of the V-groove form the contact locations, which are glued to each other for forming the core of the skirting board.

32. The method according to claim 30, wherein the plate-shaped material, seen from the substrate, successively is provided with at least a basic layer, decoration layer and transparent top layer, wherein the tip of the V-groove remains remote from the top layer and preferably remains remote from the decoration layer.
